(19) United States
(12) Patent Application Publication
(10) Pub. No.: US 2020/0267967 A1
(43) Pub. Date: Aug. 27, 2020

(54) POP-UP HUNTING BLIND APPARATUS

(71) Applicant: Thomas Edward REIGHARD, II, Warren, CT (US)

(72) Inventor: Thomas Edward REIGHARD, II, Warren, CT (US)

(21) Appl. No.: 16/794,910

(22) Filed: Feb. 19, 2020

Related U.S. Application Data
(60) Provisional application No. 62/808,301, filed on Feb. 21, 2019.

(51) Int. Cl. A01M 31/02; E04H 15/00

(52) U.S. Cl. CPC A01M 31/025; E04H 15/001

(57) ABSTRACT

A hunting blind apparatus, comprising a top assembly biased against and attachable to a bottom assembly through a hinge assembly, along with a kit for making such an apparatus and a method of using.

### RELATED APPLICATIONS

This application claims the benefit of and priority to provisional patent application U.S. 62/808,301, filed Feb. 21, 2019, the contents of which are fully incorporated by reference herein.

### BACKGROUND

Hunting of duck, waterfowl, deer and the like requires a hunter to be well-hidden until the game are within range. Hunting of fowl further requires the hunter to be able to quickly orient his gun, aim and take his shot without visual or physical obstruction. Some duck and goose hunting blinds have been made with opening covers for this purpose. However, such blinds are distracting, taking away from the hunter's focus resulting in poor aiming and inconsistent shooting. Furthermore, there is a need for hunting blinds to be portable, durable, collapsible for compact carriage, comfortable for use during several hours at a time under less than ideal conditions for human habitat. There is also a need for hunting blinds which are easily camouflaged and adaptable to different land and weather conditions. Several attempts to address these and other issues are known in the art, see for example U.S. Pat. Nos. 7,225,823; 6,938,632; 6,769,442; 6,698,131; 5,822,906; 4,798,019; 4,794,717; 4,782,616; 4,751,936; 4,738,045; 4,723,371; 4,719,716; 4,506,467; 4,186,507; 3,902,264; 3,848,352; 3,622,201; 3,848,352 and the like. However, a need remains for improved hunting blinds suitable for use in various types of hunting.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more embodiments of the invention, a hunting blind apparatus comprises a top assembly movably engageable with a bottom assembly through one or more attachment assemblies; the bottom assembly comprising a plurality of sides defining an opening bound by an upper edge; the top assembly comprising a top cover having a lower edge and dimensioned to cover at least a portion of the bottom assembly opening; each attachment assembly providing partial rotational engagement between the top assembly and the bottom assembly from an open position through a closed position, in the closed position, the top assembly is positioned to cover at least the portion of the bottom assembly opening, in the open position, the lower edge of the top assembly is arranged at an angle to the upper edge of the bottom assembly exposing a greater portion of the bottom assembly opening compared to the closed position; and one or more biasing members engaged with the top assembly, the bottom assembly, or both, such that the top assembly is biased against the bottom assembly to maintain each attachment assembly in the open position.

In another embodiment of the invention, a kit comprises components and assembly instructions necessary to form a hunting blind comprising a top assembly, one or more attachment assemblies; and one or more biasing members, engageable with an externally supplied bottom assembly, wherein the externally supplied bottom assembly comprises a plurality of sides defining an opening bound by an upper edge, such that the top assembly is movably engageable with the bottom assembly through the one or more attachment assemblies; the top assembly comprising a top cover having a lower edge and dimensioned to cover at least a portion of the bottom assembly opening; each attachment assembly providing partial rotational engagement between the top assembly and the bottom assembly from an open position through a closed position, wherein in the closed position, the top assembly is positioned to cover at least the portion of the bottom assembly opening, and wherein in the open position, the lower edge of the top assembly is arranged at an angle to the upper edge of the bottom assembly exposing a greater portion of the bottom assembly opening compared to the closed position; and wherein the one or more biasing members are engageable with the top assembly, the bottom assembly, or both such that the top assembly is biased against the bottom assembly to maintain each attachment assembly in the open position.

In still another embodiment of the invention, a method comprises the steps of providing a hunting blind apparatus according to one or more embodiments disclosed herein; disposing an occupant within the hunting blind apparatus; securing the top assembly with the release assembly such that the attachment assemblies are in the closed position, and actuating the release assembly to allow the attachment assembly to transition to the open position.

### BRIEF DESCRIPTION OF DRAWINGS

Embodiments of the hunting blind apparatus are described with reference to the following figures. The same numbers are used throughout the figures to reference like features and components in which:

FIG. 1 is a partial side cut-away view of a hunting blind apparatus in a closed position according to embodiments of this disclosure;

FIG. 2 is a side perspective view of a hunting blind apparatus in an open position according to embodiments of this disclosure;

FIG. 3 is a side view of a hinge assembly in the closed position attached to a bottom assembly according to embodiments of this disclosure;

FIG. 4 is a partial side partial cut-away view of a hinge assembly attached to the bottom assembly in the open position according to embodiments of this disclosure;

FIG. 5 is a side view of an alternative attachment assembly according to embodiments of this disclosure;

FIG. 6 is a rear view of the alternative attachment assembly shown in FIG. 5;

FIG. 7 is a side view of a top assembly according to embodiments of this disclosure;

FIG. 8 is a top view of the top assembly shown in FIG. 7;

FIG. 9 is a side exploded view of the top assembly shown in FIG. 7;

FIG. 10 is a top perspective view of a wooden enclosure bottom assembly according to embodiments of this disclosure;

FIG. 11 is a side view of a release mechanism according to embodiments of this disclosure;

FIG. 11A is an expanded view of the release mechanism shown in FIG. 11; and

FIG. 12 is a side view of the hunting blind apparatus according to embodiments of this disclosure.

### DETAILED DESCRIPTION

At the outset, it should be noted that in the development of any such actual embodiment, numerous implementation-specific decisions must be made to achieve the developer's specific goals, such as compliance with system related and business-related constraints, which will vary from one implementation to another. Moreover, it will be appreciated that such a development effort might be complex and time consuming but would nevertheless be a routine undertaking for those of ordinary skill in the art having the benefit of this disclosure. In addition, the device or composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The following definitions are provided in order to aid those skilled in the art in understanding the detailed description.

As used in the specification and claims, “near” is inclusive of “at.” All numerical values within the detailed description and the claims herein are modified by “about” or “approximately” the indicated value, and take into account experimental error and variations that would be expected by a person having ordinary skill in the art. The term “and/or” refers to both the inclusive “and” case and the exclusive “or” case, whereas the term “and or” refers to the inclusive “and” case only, and such terms are used herein for brevity. For example, a composition comprising “A and/or B” may comprise A alone, B alone, or both A and B; and a composition comprising “A and or B” may comprise A alone, or both A and B.

The term “consisting essentially of” in reference to a composition is understood to mean that in addition to the indicated component(s), the device or composition may further include additional compounds in such amounts and to the extent that the additional compounds do not substantially interfere with the essential function.

The hunting blind apparatus and the associated kits and methods of use are described, principally, in connection with various types of hunting. However, it is to be understood that the instant disclosure is not so limited, and the inventive hunting blind apparatus has other applications as should be apparent to one of skill in the art.

In embodiments, a hunting blind apparatus comprises a top assembly movably engageable with a bottom assembly through one or more attachment assemblies; the bottom assembly comprising a plurality of sides defining an opening bound by an upper edge; the top assembly comprising a top cover having a lower edge and dimensioned to cover at least a portion of the bottom assembly opening; each attachment assembly providing partial rotational engagement between the top assembly and the bottom assembly from an open position through a closed position, in the closed position, the top assembly is positioned to cover at least the portion of the bottom assembly opening, in the open position, the lower edge of the top assembly is arranged at an angle to the upper edge of the bottom assembly exposing a greater portion of the bottom assembly opening compared to the closed position; and one or more biasing members engaged with the top assembly, the bottom assembly, or both, such that the top assembly is biased against the bottom assembly to maintain each attachment assembly in the open position.

In one or more embodiments, the attachment assembly comprises a hinge releasably engageable between the top assembly and the bottom assembly, and wherein the one or more biasing members comprise gas assist lift struts, gas springs, gas struts, or a combination thereof, engaged between the bottom assembly and the top assembly. In alternative embodiments, the attachment assembly comprises a contoured channel attached to the top assembly and dimensioned to rotationally engage a corresponding portion of the upper edge of the bottom assembly; a contoured channel attached to the bottom assembly and dimensioned to rotationally engage a corresponding portion of the lower edge of the top assembly; or a combination thereof.

In one or more embodiments, the top assembly comprises two or more sections including a rear section to which the one or more attachment assemblies are engaged, and a front section, wherein the two or more sections are releasably engageable with one another to form the top assembly. Likewise, in one or more embodiments, the bottom assembly comprises a round end tank, a rectangular structure, or a combination thereof, having a length to width ratio of greater than 1 and dimensioned to contain an adult human being in a supine position, a sitting position, a sitting position with legs extended forward, or a combination thereof.

In some embodiments, at least a portion of the top assembly comprises a cover disposed over a structural frame, comprising two lower edges spaced apart from one another and connected to each other by a plurality of rib supports disposed therebetween. In some embodiments a first portion of the top cover extends away from a plane formed between the lower edges to a maximum first height, and a second portion of top cover extends away from the plane formed by the lower edges to a maximum second height, wherein the first height is greater than the second height by an amount sufficient to provide an observation window through which an external environment is viewable by an occupant located within the hunting blind when the attachment assembly is in the closed position. In one or more of such embodiments, the observation window is dimensioned and arranged to provide about 270° view and/or one or more mirror surfaces engaged with the top assembly which may be positioned, i.e., are positionable, to allow up to a 360° view of the external environment to the occupant located within the hunting blind when the attachment assembly is in the closed position.

In one or more embodiments, the observation window is at least partially covered by a flexible transparent polymeric material releasably attached to the top cover via one or more magnets, zippers, snaps, hook and loop fasteners, or a combination thereof.

In embodiments, the bottom assembly is a round end tank having an oval shape when viewed from above and comprises a horizontal bottom attached to vertical sides and having a length greater than or equal to about 5 feet, a width greater than or equal to about 1.5 feet, and a height greater than or equal to about 1 foot, formed from metal, a polymeric resin, or a combination thereof. Examples include metal or polymeric open top tanks utilized as animal feed bins or watering troughs of an adequate size, and/or the like.

In alternative embodiments, the bottom assembly has a rectangular shape when viewed from above and comprises a horizontal bottom attached to vertical sides having a length greater than or equal to about 5 feet, a width greater than or equal to about 1.5 feet, and a height greater than or equal to about 1 foot, formed from dimensional lumber, plywood, or a combination thereof. Examples include a 2×4 frame covered by plywood sheeting, or simply plywood sheeting formed into the appropriate shape in the appropriate dimensions using adhesives, nails, threaded fasteners, and the like.

In one or more embodiments, the hunting blind apparatus further comprises a release assembly, preferably operable at least from within the hunting blind apparatus, which maintains the attachment assembly in the closed position, e.g., the top down and covering the bottom assembly, and which upon actuation allows the attachment assembly to transition to the open position, along with it the top allowing the hunter to act.

In one or more embodiments, the biasing force between the top assembly and the bottom assembly is sufficient to cause the attachment assemblies to transition from the closed position to the open position in less than or equal to about 5 seconds, preferably less than or equal to about 2 seconds, preferably in about 1 second or less upon actuation of the release assembly.

In one or more embodiments, at least a portion of the top assembly comprises a water repellant fabric attached to a tubular structural frame. Likewise, in embodiments, the bottom assembly may be at least partially covered in a repellant fabric, polymeric sheet (e.g., polyethylene film or sheeting, and/or the like to prevent water and/or insects or reptiles from entering the interior of the apparatus. In some embodiments, the apparatus further comprises one or more resilient members engageable with an outer surface of the top assembly, the bottom assembly, or both, suitable to frictionally engage camouflaging elements from a natural environment. Examples include bungee cords, ropes, and the like, which allow camouflaging elements such as local grass or other plants to be temporarily engaged with the apparatus to obscure the apparatus from wildlife.

In one or more embodiments, the top assembly further comprises one or more openings disposed therethrough, dimensioned to allow a portion of a firearm to protrude therethrough, a platform located on an outer side of top assembly dimensioned to support a portion of firearm, or a combination thereof, preferably so that the firearm may be fired from within the apparatus without opening the top as would be beneficial when hunting terrestrial mammals such as deer.

In one or more embodiments, the apparatus further comprises one or more wheels or wheel and axle assemblies, which are attachable to the assembly, preferably to an external surface of the bottom assembly and/or through a portion of the bottom assembly, and a handle portion attachable to apparatus, again preferably to the bottom assembly, dimensioned and arranged to allow movement of the hunting blind apparatus from one location to another, e.g., by pulling or pushing on the handle to cause the apparatus to roll.

In one or more embodiments, a kit comprises components and optionally assembly instructions or provides access to assembly instructions, necessary to form a hunting blind apparatus according to one or more embodiments disclosed herein. Preferably, the kit comprises components and optionally assembly instructions engageable with an externally supplied bottom assembly. In one such embodiment, the externally supplied bottom assembly is formed from a round end tank or a rectangular structure comprising a horizontal bottom attached to vertical sides having a length greater than or equal to about 5 feet, a width greater than or equal to about 1.5 feet, and a height greater than or equal to about 1 foot, formed from metal, a polymeric resin, dimensional lumber, plywood, or a combination thereof. In one embodiments, the externally supplied bottom assembly is a commercially available round end tank, such as a metal or resin tank often utilized as an animal feed bin or watering trough. In other embodiments, the externally supplied bottom assembly is formed from wood or other materials, e.g., dimensional lumber and/or plywood, held together with adhesives and/or various types of fasteners.

In one or more embodiments, a hunting blind apparatus comprises a top assembly attachable to a bottom assembly through a hinge assembly; the bottom assembly comprising a plurality of sides defining an opening bound by an upper edge; the top assembly comprising a top assembly (also referred to as a top cover) dimensioned along a lower edge thereof to at least partially cover the opening of the bottom assembly; the hinge assembly having an open position and a closed position, providing partial rotational engagement between the top assembly and a bottom attachment plate attachable to the bottom assembly, in the closed position, the lower edge of the top assembly is arranged essentially parallel to the upper edge of the bottom assembly such that the top assembly is positioned to at least partially cover the opening of the bottom assembly, in the open position, the lower edge of the top assembly is arranged at an angle to the upper edge of the bottom assembly exposing a greater portion of the opening of the bottom assembly than when the hinge is in the closed position; and a biasing member engaged with and between the top assembly and the bottom attachment plate, the bottom assembly, or both, biased to maintain the hinge assembly in the open position. In such an embodiment, the hinge assembly may comprise a top plate releasably attachable to the top assembly by one or more threaded fasteners, pins, slots, clamps, or a combination thereof, and/or may further comprise a stop arm extending away from the top plate towards the bottom attachment plate dimensioned to engage the bottom attachment plate when the hinge assembly is in the open position. In embodiments, the bottom attachment plate is releasably attachable to the bottom assembly via one or more threaded fasteners, pins, slots, clamps, or a combination thereof.

In some embodiments, the biasing member comprises one or more resilient members engaged with and between the top assembly and the bottom attachment plate. In some embodiments, the hinge assembly further comprises an attachment arm extending away from the bottom attachment plate to which an end of one or more resilient members are attached.

In embodiments, the sides of the bottom assembly define an inner area bound by the plurality of sides, and wherein the hinge assembly is attachable to a portion of one or more sides located external to the inner area. In embodiments, the hinge assembly further comprises an inner attachment plate engageable with the bottom attachment plate such that a side of the bottom assembly is sandwiched between the inner and bottom attachment plates. In embodiments, the inner attachment plate is engageable with the bottom attachment plate via threaded members disposed through holes in a side of the bottom assembly. In embodiments, the hinge assembly further includes one or more lifting assist assemblies engaged with, and disposed between, the inner attachment plate and the top assembly, wherein lifting assist assembly is biased toward maintaining the hinge in the open position.

In embodiments, the top assembly has a length to width ratio of greater than 1 and is dimensioned to at least partially cover the bottom assembly having a length, width and depth sized to contain an adult human being in a supine position, a sitting position, a sitting position with legs extended forward, or a combination thereof. In embodiments, the bottom assembly has a length to width ratio of greater than or equal to about 2.5, and a ratio of width to height of greater than or equal to about 1. In embodiments, the bottom assembly includes a bottom side attached about the plurality of sides defining an inner area having an opening bound by the upper edge.

In embodiments, the top assembly comprises two lower sides spaced apart from one another defining a lower edge plane comprising the lower edge, the two lower sides connected to each other by one or more structural members disposed there between. In embodiments, a bottom surface of the lower edge is dimensioned to engage an upper surface of the upper edge of the bottom assembly when the hinge assembly is in the closed position.

In embodiments, the top assembly comprises a structural frame comprising the two lower sides connected to each other by a plurality of rib supports disposed therebetween. In embodiments, the structural frame comprises a plurality of tubular members attached to one another via welds, threaded members, rivets, frictional connectors, push-button connectors, or a combination thereof.

In embodiments, at least two of the plurality of rib supports comprise a portion which extends in a direction away from the lower edge plane such that a cross section perpendicular to the lower sides of at least a portion of the top assembly is generally concave in shape with respect to the lower edge plane. In embodiments, two or more of the rib supports are attached to one another by one or more additional support members oriented essentially orthogonal to the rib supports.

In embodiments, a first portion of the top assembly is located proximate to the hinge assembly, and the first distance exceeds the second distance by an amount sufficient to provide an observation window from within the hunting blind when the hinge assembly is in the closed position. In embodiments, the top assembly further comprises a releasable attachment assembly comprising an attached orientation in which a portion of the top assembly is releasably engaged with corresponding portion of the bottom assembly thereby maintaining the hinge assembly in the closed position, and an actuated orientation in which the portion of the top assembly is disengaged from the corresponding portion of the bottom assembly thereby allowing the hinge assembly to orient into the open position, opening the hunting blind. In embodiments, the attachment assembly comprises a spring-loaded hook and latch assembly, actuated by a cable having an end located within a corresponding support disposed into the top assembly.

In embodiments of the invention, a method to produce a hunting blind comprises the steps of providing a hunting blind apparatus according to any one or combination of embodiments disclosed herein and attaching the hunting blind apparatus to a suitable bottom assembly to produce the hunting blind.

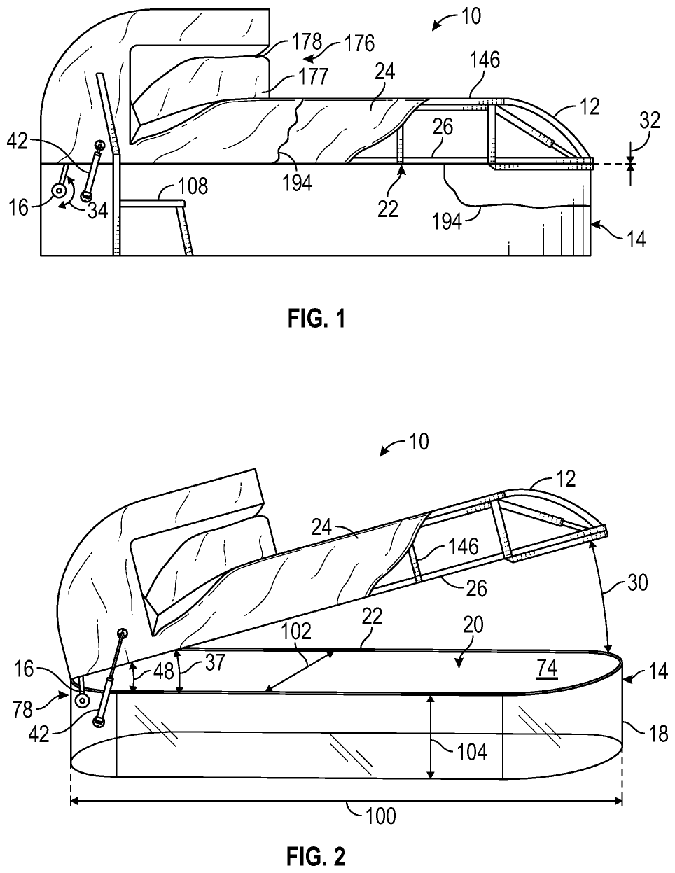

Turning to FIG. 1 which shows a side view of an embodiment of a hunting blind apparatus, generally referred to as 10, oriented in a closed position 32 comprising a top assembly 12 movably engageable with a bottom assembly 14 through one or more attachment assemblies 16.

FIG. 2 shows a side perspective view of an embodiment of the hunting blind apparatus 10 in an open position 30, the bottom assembly comprising a plurality of sides 18 defining an opening 20, e.g., an opening of the bottom assembly, bound by an upper edge 22. The top assembly 12 comprising a top cover 24 disposed over and attached to a frame 146. The top assembly 12 comprising a lower edge 26 dimensioned to at least partially cover the opening of the bottom assembly 20 when in the closed position, generally referred to as 32. Each attachment assembly 16 having a corresponding open position and a closed position, providing partial rotational engagement 34 between the top assembly 12 and the bottom assembly 14. As shown in FIG. 1, in the closed position 32, the top assembly 12 is positioned to at least partially cover the opening of the bottom assembly 20; in the open position 30, the lower edge 26 of the top assembly 12 is arranged at an angle 37 to the upper edge 22 of the bottom assembly 14 exposing a greater portion of the opening of the bottom assembly 20 compared to when the attachment assembly 16 is in the closed position. The hunting apparatus further including one or more biasing members 42 engaged with the top assembly 12, the bottom assembly 14, or both, biased 48 to maintain the attachment assembly 16 and thus the top assembly 12 in the open position 30.

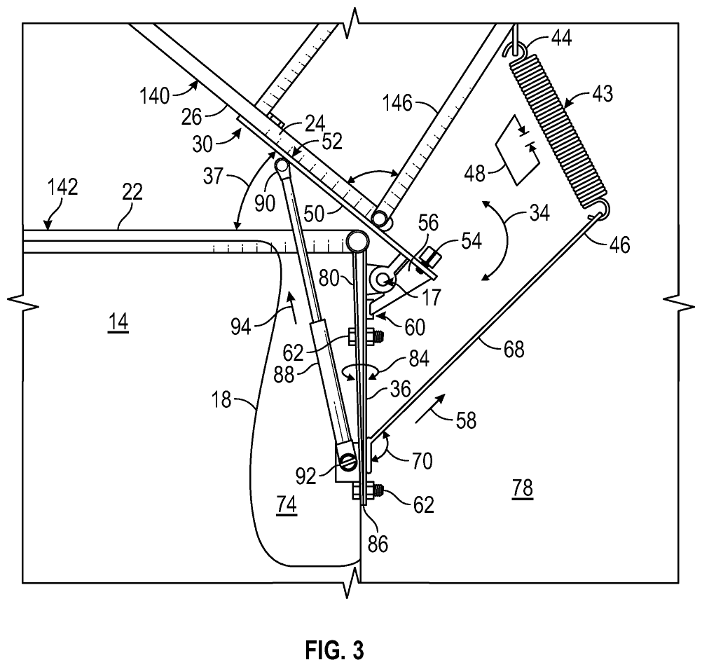

As shown in FIG. 2, in embodiments the biasing member 42 is a gas-assist lift spring. As shown in FIG. 3, in other embodiments the biasing member may be one or more resilient members such as springs 43.

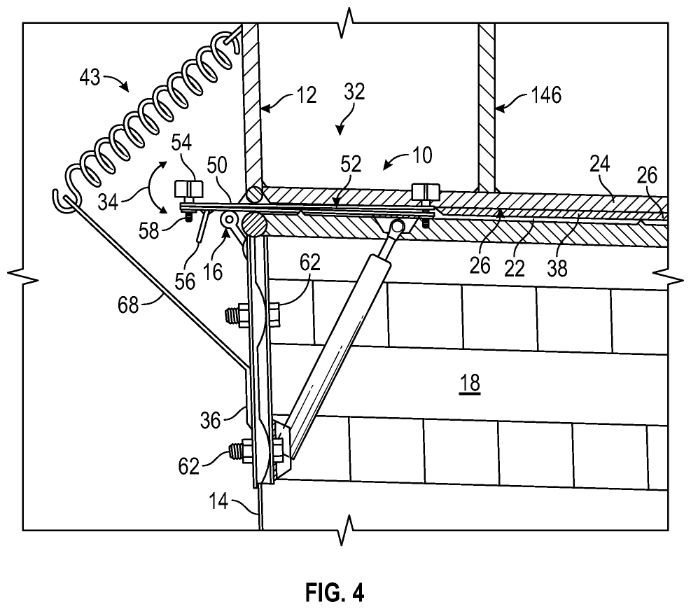

FIG. 3 shows an embodiment of the apparatus 10 in the open position 30 in which the attachment assembly 16 utilizes the constrictive force of springs to bias the top assembly 12 towards the open position 30 in relation to the bottom assembly 14. The partial side view of the attachment assembly 16 comprising a hinge 17 and an external resilient member assembly e.g., springs 43, attached to the bottom assembly 14 according to embodiments of the invention. The top assembly 12 dimensioned along lower edge 26 thereof to at least partially cover the opening of the bottom assembly 20. The hinge 17 having an open position 30 and a closed position 32 shown in FIG. 4, provided by partial rotational engagement 34 between the top cover 12 and a bottom attachment plate 36 attachable to the bottom assembly 14. In the closed position shown in FIG. 4, the lower edge 26 is arranged essentially parallel 38 to the upper edge 22 of the bottom assembly 14 such that the top assembly 12 is positioned to at least partially cover the opening of the bottom assembly.

In the open position 30, the lower edge 26 is arranged at an angle 37 to the upper edge 22 of the bottom assembly 14 exposing a greater portion of the opening 20 of the bottom assembly 14 than when the attachment assembly 16 is in the closed position 32. In the embodiment shown in FIGS. 3 and 4, the hunting apparatus may 10 further include one or more spring biasing members 43 engaged with and between the top cover 24, shown as item 44, and engaged the bottom assembly as indicated by 46, with a bottom attachment plate 36, e.g., through attachment arm 68 and thus to the bottom assembly 14. The biasing member 43 being biased 48 to maintain the hinge 17 in the open position 30.

In embodiments, the attachment assembly 16 comprises a top plate 50 releasably attachable 52 to the top assembly 12 by one or more threaded fasteners, pins, slots, clamps, or a combination thereof, generally indicated as 54.

In embodiments, the attachment assembly 16 further comprises a stop arm 56 extending away 58 from the bottom assembly 16, e.g., towards the bottom attachment plate 36. The stop arm 56 being dimensioned to engage the bottom attachment plate 36 or another portion of the top assembly 12 when the attachment assembly 16 is in the open position 30.

In embodiments, the attachment assembly 16 is releasably attachable to the bottom assembly 14 via one or more threaded fasteners, pins, slots, clamps, or a combination thereof, generally represented as 62. In the embodiment shown, the biasing member 42 comprises one or more resilient members generally indicated as 64, e.g., springs 43, engaged with (44 and 46) and between the top assembly 12 and the bottom assembly 14. In addition to springs, elastic cords and other types of constrictive resilient members may be employed.

In embodiments, the attachment assembly 16 may further include an attachment arm 68 extending away 58, e.g., at angle 70, from the bottom attachment plate 36 to which an end of one or more resilient members 64 are attached 46.

In some embodiments, the sides 18 of the bottom assembly 14 define an inner area 74 bound by the plurality of sides 18. In embodiments, the attachment assembly 16 is attachable to a portion of one or more sides 18 and is at least partially located external 78 to the inner area 74 of the bottom assembly 14.

As shown in the cut-away view of FIG. 3, in embodiments, the attachment assembly 16 further comprises an inner attachment plate 80 engageable with the bottom attachment plate 36 such that a side 18 of the bottom assembly 14 is sandwiched between 84 the inner plate 80 and the bottom attachment plate 36. As shown, the inner attachment plate 80 may be engageable with the bottom attachment plate 36 via threaded members 62 disposed through holes 86 in a side 18 of the bottom assembly 14.

In embodiments, the attachment assembly 16 may further include one or more lifting assist assemblies 88 engaged with the top assembly 12, e.g., via an inner attachment plate at 92, and a top attachment plate 90, wherein lifting assist assembly 88 is biased 94 toward maintaining the attachment assembly 16 in the open position 30.

In other embodiments, as shown in FIGS. 1 and 2, the attachment assembly comprises a hinge or pivot releasably engageable between the top assembly and the bottom assembly, and the one or more biasing members comprise or consist essentially of gas assist lift struts 42 also referred to as gas springs, gas struts, or a combination thereof, engaged between the bottom assembly 14 and the top assembly 12 and which provide some if not the entire biasing force 48 which causes a transformation from a closed position 32 to an open position 30 of the top assembly 12 relative to the bottom assembly 14.

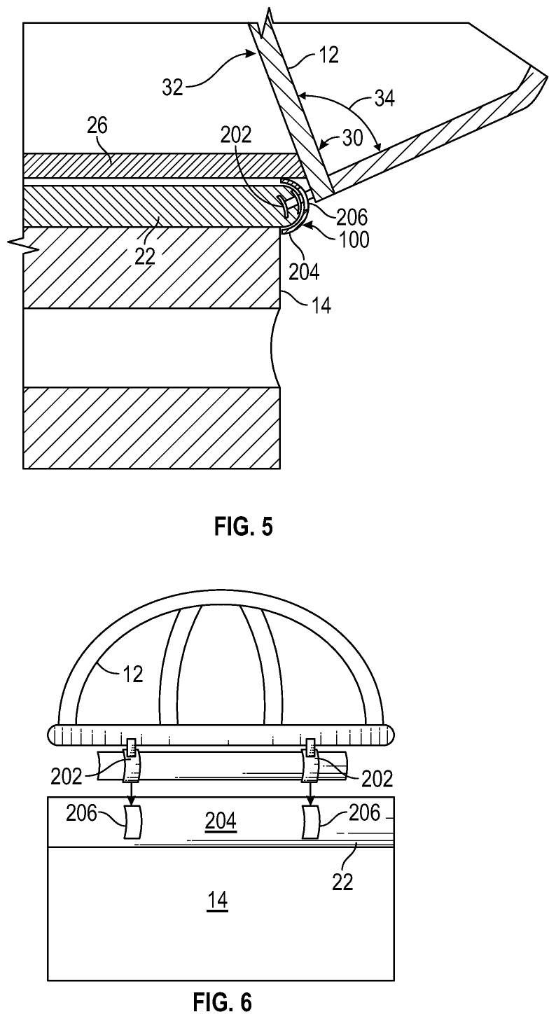

In embodiments, the attachment assembly comprises one or more hinges providing rotational engagement between the top assembly and the bottom assembly. As shown in FIGS. 5 and 6, which show a side view and a back view, respectively of the bottom assembly 14 rotationally engaged with the top assembly 12 via a contoured channel 100 attached to the top assembly 12 and dimensioned to rotationally engaged 34 with a corresponding portion of the upper edge 22 of the bottom assembly 14. Likewise, in embodiments, the contoured channel may be attached to the bottom assembly and dimensioned to rotationally engage a corresponding portion of the lower edge 26 of the top assembly 12, or a combination thereof. In the embodiment shown, the portion of the attachment assembly attached to the top assembly which rotationally engages the bottom assembly, the pivots (102), may be engaged with the bottom assembly by a pressure fit clip 104 which has slots disposed therethrough to hold the pivots in contact while allowing the rotation necessary for the top assembly to transition from the closed position to the open position and back again.

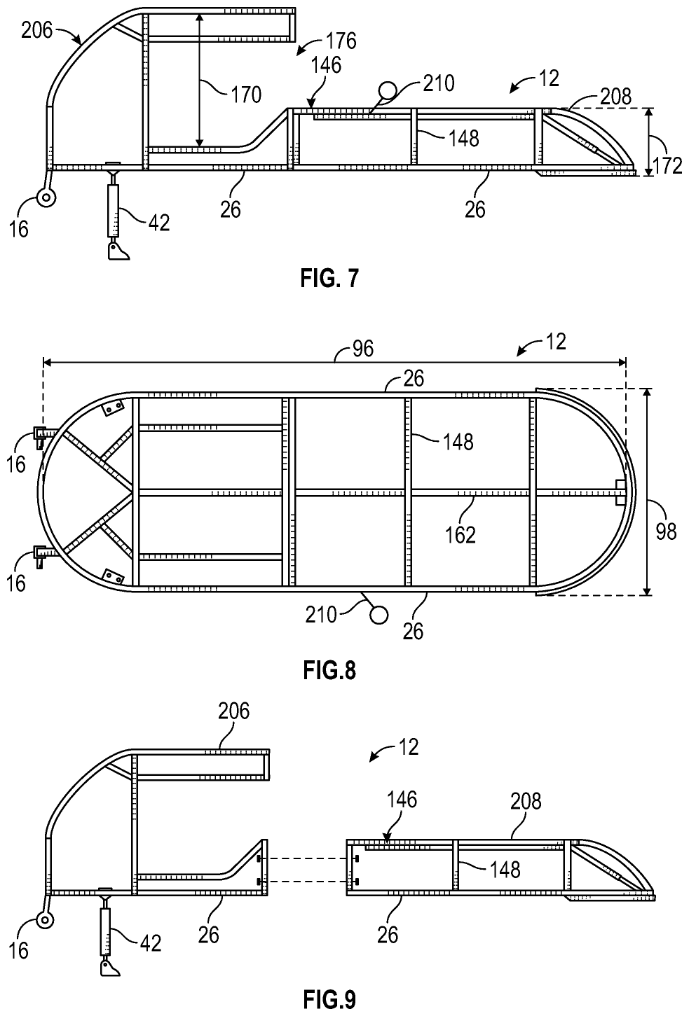

As shown in FIGS. 7, 8, and 9, which show a side view, a top view and an exploded side view of a portion of the top assembly 12, in embodiments the top assembly comprises two or more sections including a rear section 206 to which the one or more attachment assemblies 16 are engaged, and at least one additional front section 208, wherein the two or more sections 206 and 208 are releasably engageable with one another to form the top assembly 12.

In embodiments the top assembly 12 has a length 96 to width 98 ratio of greater than 1 and is dimensioned to at least partially cover, preferably completely cover the bottom assembly 14 having a length 100, width 102 and depth 104 (see FIG. 2) sized to contain an adult human being in a supine position, a sitting position, a sitting position with legs extended forward, or a combination thereof.

In embodiments, the top assembly 12 and/or the bottom assembly 14 has a length 100 to width 102 ratio of greater than or equal to about 2.5, or 3, and a ratio of height 104 to width 102 of greater than or equal to about 0.5. In embodiments, the bottom assembly is a round end tank, e.g., a feed bin, having an oval shape when viewed from above and comprises a horizontal bottom attached to vertical sides and having a length greater than or equal to about 5 feet, a width greater than or equal to about 1.5 feet, and a height greater than or equal to about 1 foot, formed from metal, a polymeric resin, or a combination thereof.

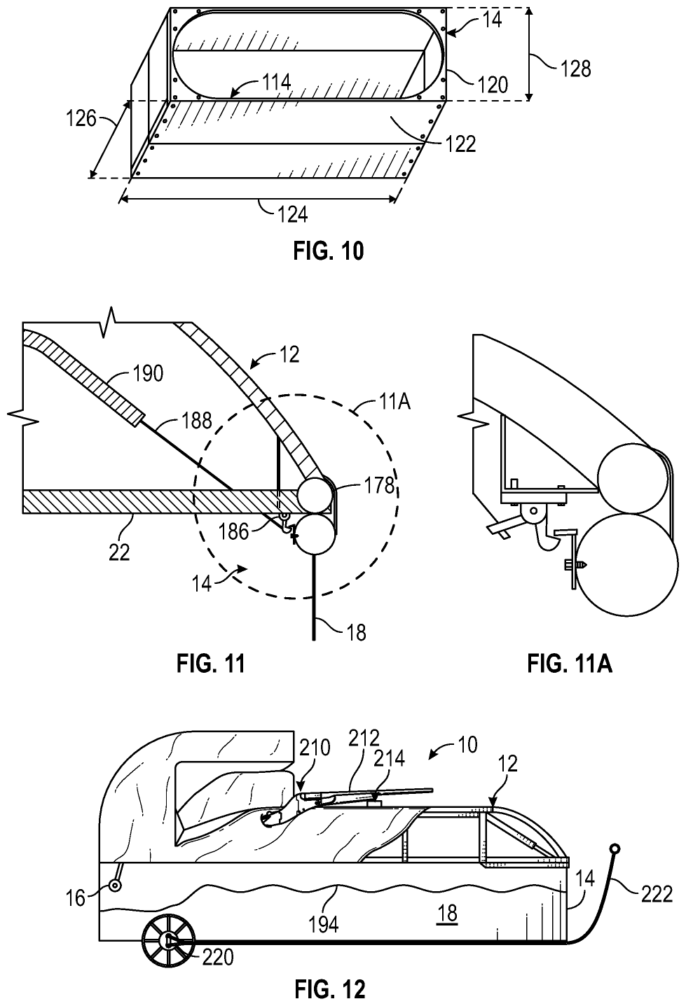

As shown in FIG. 10, in embodiments the bottom assembly 14 has a rectangular shape when viewed from above and comprises a horizontal bottom 114 attached to vertical sides 122 having a length 124 greater than or equal to about 5 feet, a width 128 greater than or equal to about 1.5 feet, and a height 126 greater than or equal to about 1 foot, formed from any suitable material, preferably dimensional lumber, plywood, or a combination thereof.

As shown in FIGS. 1 and 2, at least a portion of the top assembly 12 comprises a cover 24 disposed over a structural frame 146. As shown in FIGS. 7, 8, and 9, the structural frame, generally referred to as 146, comprising two lower edges 26 spaced apart from one another and connected to each other by a plurality of rib supports 148 disposed therebetween. In embodiments, the lower edge 26 is dimensioned to engage at least a portion of the upper edge 22 of the bottom assembly 14 when the attachment assembly 16 is in the closed position (see FIG. 1). As shown in the figures, in embodiments, the top assembly 12 comprises a structural frame 146 comprising the two lower sides 26 connected to each other by a plurality of rib supports 148 disposed therebetween. In embodiments, the structural frame 146 comprises a plurality of tubular members attached to one another via welds, threaded members, rivets, frictional connectors, push-button connectors, or a combination thereof.

In embodiments, the first portion 206 of the top cover extends away from a plane formed between the lower edges 26 to a maximum first height 170, and the second portion 208 of top assembly extends away from the plane formed by the lower edges 26 to a maximum second height 172, wherein the first height 170 is greater than the second height 172 by an amount sufficient to provide an observation window 176 through which an external environment is viewable by an occupant located within the hunting blind when the attachment assembly 16 is in the closed position 32. In embodiments, the top assembly is generally concave in shape with respect to the lower edge plane.

As shown in FIGS. 1 and 2, the top assembly 12 may further include a flexible or fabric cover 24, preferably a waterproof cover. In embodiments, the observation window 176 is at least partially covered by a flexible transparent polymeric material 177 releasably attached 178 to the top assembly via one or more magnets, zippers, snaps, hook and loop fasteners, or a combination thereof. Accordingly, in embodiments at least a portion of the top assembly comprises a water repellant fabric attached to a tubular structural frame.

In embodiments, the apparatus 10 further comprises one or more resilient members 194, e.g., bungee cords, engageable with an outer surface of the top assembly, the bottom assembly, or both, suitable to frictionally engage camouflaging elements from a natural environment.

As shown in FIG. 8, in embodiments two or more of the rib supports 148 are attached to one another by one or more additional support members 162 oriented essentially orthogonal to the rib supports 148. In embodiments, at least a portion of the top assembly 12 is dimensioned to extend away from lower edge 26 such that when the top assembly is in the closed position, is covers more than the top of the bottom assembly 14, e.g., forming a drip edge or a more weather tight seal.

In embodiments, the observation window 176 is dimensioned and arranged to provide at least about 180°, preferably at least about 270° view and/or one or more mirror surfaces 210, e.g., rear view mirrors, may be engaged with the top assembly 12 which are positionable to allow up to a 360° view of the external environment to the occupant located within the hunting blind when the attachment assembly is in the closed position. This arrangement also allows for placement of a chair or other support 108 (see FIG. 1) within the apparatus to provide comfort for the hunter.

In embodiments the top assembly 12 further comprises a releasable attachment assembly 178 comprising an attached orientation as shown in FIG. 11, in which a portion of the top assembly 12 is releasably engaged with corresponding portion of the bottom assembly 14 thereby maintaining the top assembly in the closed position, and an actuated orientation in which the portion of the top assembly 12 is disengaged from the corresponding portion of the bottom assembly 14 thereby allowing the attachment assembly 16 to be forced by the biasing force 48 and then orient into the open position, opening the hunting blind. Preferably, the release assembly 178, is operable from within the hunting blind apparatus and optionally from outside of the blind to allow access therein.

In embodiments, the attachment assembly 178 comprises a spring-loaded hook and latch assembly 186, actuated by a cable 188 having an end located within a corresponding support 190 disposed into the top assembly 12. The top is opened by pulling on a handle or other mechanism from within the closed blind. In embodiments, the biasing force 48 between the top assembly 12 and the bottom assembly 14 is sufficient to cause the attachment assembly 16 to transition from the closed position 32 to the open position 30 in less than or equal to about 5 seconds, preferably less than or equal to about 2 seconds, preferably in about 1.5 seconds or less upon actuation of the release assembly 178.

As shown in FIG. 12, in embodiments, the top assembly 12 further comprises one or more openings disposed therethrough 210, dimensioned to allow a portion of a firearm 212 to protrude therethrough, and a platform 214 located on an outer side of top assembly 12 dimensioned to support a portion of firearm, or a combination thereof. As is also shown, in embodiments, the hunting blind apparatus 10 may further comprise one or more wheels 220 attachable to an external surface of the bottom assembly 14, and/or via a removable axle through the bottom assembly, and a handle 222 attachable to the bottom assembly, dimensioned and arranged to allow movement of the hunting blind apparatus from one location to another. The wheels and handle may be removably attached so that they may be disengaged from the apparatus once in location.

In embodiments, the invention comprises a kit for producing a hunting blind according to one or more embodiments disclosed herein. In embodiments, the kit comprises components and assembly instructions necessary to form a hunting blind comprising a top assembly, one or more attachment assemblies; and one or more biasing members, engageable with an externally supplied bottom assembly, wherein the externally supplied bottom assembly comprises a plurality of sides defining an opening bound by an upper edge, such that the top assembly is movably engageable with the bottom assembly through the one or more attachment assemblies; the top assembly comprising a top cover having a lower edge and dimensioned to cover at least a portion of the bottom assembly opening; each attachment assembly providing partial rotational engagement between the top assembly and the bottom assembly from an open position through a closed position, wherein in the closed position, the top assembly is positioned to cover at least the portion of the bottom assembly opening, and wherein in the open position, the lower edge of the top assembly is arranged at an angle to the upper edge of the bottom assembly exposing a greater portion of the bottom assembly opening compared to the closed position; and wherein the one or more biasing members are engageable with the top assembly, the bottom assembly, or both such that the top assembly is biased against the bottom assembly to maintain each attachment assembly in the open position.

In embodiments, the kit comprises components dimensioned to form the hunting blind assembly utilizing as the externally supplied bottom assembly, preferably provided by or formed from a round end tank commercially available, or from a rectangular structure produced using readily available materials comprising a horizontal bottom attached to vertical sides having a length greater than or equal to about 5 feet, a width greater than or equal to about 1.5 feet, and a height greater than or equal to about 1 foot, formed from metal, a polymeric resin, dimensional lumber, plywood, or a combination thereof.

Accordingly, the instant disclosure is directed to a pop-up hunting blind that mounts on a commonly available feed bin or wooden box. One of skill in the art may obtain the relatively inexpensive feed bin, attach the components disclosed herein to produce the blind, and may bury a portion thereof in the ground at a hunting site and/or may set the blind on top of the ground. The instant blind provides a hunter more than adequate room for himself, his equipment, and a retrieval dog, optionally a heater and a chair, while still maintaining an extremely low profile previously unknown in the art. Embodiments disclosed herein provide a hunter with a dry warm rain and wind proof hunting blind that is as low profile as a lay out blind, but with much more room.

Furthermore, in cases where the hunter is not on his property, of the blind must be moved from place to place, the blind provides easy and quick set up with natural camouflage allowing the hunter to sit in a reclined seat while maintaining an extremely low profile. When the game flies into the field or on a pond in range, the hunter is able to pull the handle and the top pops up automatically providing a clear, unencumbered shot.

These benefits are unknown in the art, which provides lay out blinds dug out of wet holes in the ground or sleeping bags with open tops. Unlike other blinds in the art, the instant blind can handle strong wind or inclement weather, while providing a safe and comfortable inner chamber to keep the weather out. In addition, the attachable feature of the apparatus allows for multiple feed bins to be located in different hunting locations and then simply mount the blind apparatus with the thumb screws, hook up the springs, and the blind is ready for hunting in less than 3 minutes.

In addition, in embodiments in which lightweight steel or aluminum tube frame is used, the frame may be painted and/or powder coated for corrosion resistance. The tubes may be welded together or be disassembled for transport. In embodiments, a camouflage weather resistant canvas cover which is stretched over the frame may be snapped into place. Preferably the fabric has an overhangs at the bottom of the frame which overhangs to keep the wind and weather out when the Pop Top is closed. In embodiments, the observation window is a zippered front flexible clear window, and 2 flexible side windows used to watch for game may also be included. In addition, a flexible rubber rain resistant vent may be provided in the back at the top to allow for air movement. There at thin G strings around the outside of the canvas in multiple places. This is used to attach grasses sticks and leads that you find at the hunting site, allowing the hunting blind to completely blend into its natural environment.

In addition, a slot in the back portion of the canvas cover may be included which allows a piece of the frame to sick though. This piece of frame is set at an angle and has Velcro on the top to attached to the canvas cover and keep the weather out. This piece of framing has four holes to except the four lifting springs.

In other embodiments, a method comprises the steps of providing a hunting blind apparatus according to one or more embodiments disclosed herein, disposing an occupant within the hunting blind apparatus; securing the top assembly with the release assembly such that the attachment assemblies are in the closed position, and actuating the release assembly to allow the attachment assembly to transition to the open position.

It should be understood that the foregoing description of the invention is intended merely to be illustrative thereof and that other equivalents, embodiments and modifications of the invention may be apparent to those skilled in the art.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 for any limitations of any of the claims herein, except for those in which the claim expressly uses the words ‘means for’ together with an associated function.

I claim:

1. A hunting blind apparatus, comprising:
a top assembly movably engageable with a bottom assembly through one or more attachment assemblies;
the bottom assembly comprising a plurality of sides defining an opening bound by an upper edge;
the top assembly comprising a top cover having a lower edge and dimensioned to cover at least a portion of the bottom assembly opening;
each attachment assembly providing partial rotational engagement between the top assembly and the bottom assembly from an open position through a closed position,
in the closed position, the top assembly is positioned to cover at least the portion of the bottom assembly opening,
in the open position, the lower edge of the top assembly is arranged at an angle to the upper edge of the bottom assembly exposing a greater portion of the bottom assembly opening compared to the closed position; and
one or more biasing members engaged with the top assembly, the bottom assembly, or both, such that the top assembly is biased against the bottom assembly to maintain each attachment assembly in the open position.

2. The hunting blind apparatus of claim 1, wherein the attachment assembly comprises a hinge and/or pivot releasably engageable between the top assembly and the bottom assembly, and wherein the one or more biasing members comprise gas assist lift struts, gas springs, gas struts, or a combination thereof, engaged between the bottom assembly and the top assembly.

3. The hunting blind apparatus of claim 1, wherein the attachment assembly comprises:
a contoured channel attached to the top assembly and dimensioned to rotationally engage a corresponding portion of the upper edge of the bottom assembly;
a contoured channel attached to the bottom assembly and dimensioned to rotationally engage a corresponding portion of the lower edge of the top assembly;
or a combination thereof.

4. The hunting blind apparatus of claim 1, wherein the top assembly comprises two or more sections including a rear section to which the one or more attachment assemblies are engaged, and a front section, wherein the two or more sections are releasably engageable with one another to form the top assembly.

5. The hunting blind apparatus of claim 1, wherein the bottom assembly comprises a round end tank, a rectangular structure, or a combination thereof, having a length to width ratio of greater than 1 and dimensioned to contain an adult human being in a supine position, a sitting position, a sitting position with legs extended forward, or a combination thereof.

6. The hunting blind apparatus of claim 1, wherein at least a portion of the top assembly comprises a cover disposed over a structural frame, comprising two lower edges spaced apart from one another and connected to each other by a plurality of rib supports disposed therebetween.

7. The hunting blind apparatus of claim 1, wherein a first portion of the top cover extends away from a plane formed between the lower edges to a maximum first height, and a second portion of top cover extends away from the plane formed by the lower edges to a maximum second height, wherein the first height is greater than the second height by an amount sufficient to provide an observation window through which an external environment is viewable by an occupant located within the hunting blind when the attachment assembly is in the closed position.

8. The hunting blind apparatus of claim 7, wherein the observation window is dimensioned and arranged to provide about 270° view and/or one or more mirror surfaces engaged with the top assembly which are positionable to allow up to a 360° view of the external environment to the occupant located within the hunting blind when the attachment assembly is in the closed position.

9. The hunting blind apparatus of claim 8, wherein the observation window is at least partially covered by a flexible transparent polymeric material releasably attached to the top cover via one or more magnets, zippers, snaps, hook and loop fasteners, or a combination thereof.

10. The hunting blind apparatus of claim 1, wherein the bottom assembly is a round end tank having an oval shape when viewed from above and comprises a horizontal bottom attached to vertical sides and having a length greater than or equal to about 5 feet, a width greater than or equal to about 1.5 feet, and a height greater than or equal to about 1 foot, formed from metal, a polymeric resin, or a combination thereof.

11. The hunting blind apparatus of claim 1, wherein the bottom assembly has a rectangular shape when viewed from above and comprises a horizontal bottom attached to vertical sides having a length greater than or equal to about 5 feet, a width greater than or equal to about 1.5 feet, and a height greater than or equal to about 1 foot, formed from dimensional lumber, plywood, or a combination thereof.

12. The hunting blind apparatus of claim 1, further comprising a release assembly, operable from within the hunting blind apparatus, which maintains the attachment assembly in the closed position, and which upon actuation allows the attachment assembly to transition to the open position.

13. The hunting blind apparatus of claim 12, wherein a biasing force between the top assembly and the bottom assembly is sufficient to cause the attachment assemblies to transition from the closed position to the open position in less than or equal to about 5 seconds, preferably less than or equal to about 2 seconds, upon actuation of the release assembly.

14. The hunting blind apparatus of claim 1, wherein at least a portion of the top assembly comprises a water repellant fabric attached to a tubular structural frame.

15. The hunting blind apparatus of claim 1, further comprising one or more resilient members engageable with an outer surface of the top assembly, the bottom assembly, or both, suitable to frictionally engage camouflaging elements from a natural environment.

16. The hunting blind apparatus of claim 1, wherein the top assembly further comprises one or more openings disposed therethrough, dimensioned to allow a portion of a firearm to protrude therethrough, a platform located on an outer side of top assembly dimensioned to support a portion of firearm, or a combination thereof.

17. The hunting blind apparatus of claim 1, further comprising one or more wheels attachable to an external surface of the bottom assembly, and/or a handle attachable to the bottom assembly, dimensioned and arranged to allow movement of the hunting blind apparatus from one location to another.

18. A kit comprising components and assembly instructions necessary to form a hunting blind comprising:
a top assembly:
one or more attachment assemblies; and
one or more biasing members, engageable with an externally supplied bottom assembly, wherein the externally supplied bottom assembly comprises a plurality of sides defining an opening bound by an upper edge, such that the top assembly is movably engageable with the bottom assembly through the one or more attachment assemblies;
the top assembly comprising a top cover having a lower edge and dimensioned to cover at least a portion of the bottom assembly opening;
each attachment assembly providing partial rotational engagement between the top assembly and the bottom assembly from an open position through a closed position,
wherein in the closed position, the top assembly is positioned to cover at least the portion of the bottom assembly opening, and wherein in the open position, the lower edge of the top assembly is arranged at an angle to the upper edge of the bottom assembly exposing a greater portion of the bottom assembly opening compared to the closed position; and
wherein the one or more biasing members are engageable with the top assembly, the bottom assembly, or both such that the top assembly is biased against the bottom assembly to maintain each attachment assembly in the open position.

19. The kit of claim 18, wherein components are dimensioned to form the hunting blind assembly utilizing as the externally supplied bottom assembly formed from a round end tank or a rectangular structure comprising a horizontal bottom attached to vertical sides having a length greater than or equal to about 5 feet, a width greater than or equal to about 1.5 feet, and a height greater than or equal to about 1 foot, formed from metal, a polymeric resin, dimensional lumber, plywood, or a combination thereof.

20. A method comprising:
providing a hunting blind apparatus, comprising:
a top assembly movably engageable with a bottom assembly through one or more attachment assemblies;
the bottom assembly comprising a plurality of sides defining an opening bound by an upper edge;
the top assembly comprising a top cover having a lower edge and dimensioned to cover at least a portion of the bottom assembly opening;
each attachment assembly providing partial rotational engagement between the top assembly and the bottom assembly from an open position through a closed position,
in the closed position, the top assembly is positioned to cover at least the portion of the bottom assembly opening,
in the open position, the lower edge of the top assembly is arranged at an angle to the upper edge of the bottom assembly exposing a greater portion of the bottom assembly opening compared to the closed position;
one or more biasing members engaged with the top assembly, the bottom assembly, or both, such that the top assembly is biased against the bottom assembly to maintain each attachment assembly in the open position; and a release assembly, operable from within the hunting blind apparatus, which maintains the attachment assembly in the closed position, and which upon actuation allows the attachment assembly to transition to the open position;
optionally disposing an occupant within the hunting blind apparatus;
securing the top assembly with the release assembly such that the attachment assemblies are in the closed position, and
actuating the release assembly to allow the attachment assembly to transition to the open position.
